(19) United States
(12) Patent Application Publication
(10) Pub. No.: US 2018/0354562 A1
(43) Pub. Date: Dec. 13, 2018

(54) BAMBOO AND/OR VEGETABLE CANE COMPOSITE DECKING AND PROCESS

(71) Applicant: Resource Fiber LLC, Homewood, AL (US)

(72) Inventors: Leland Slaven, JR., Tampa, FL (US); David Knight, Bainbridge Island, WA (US)

(21) Appl. No.: 16/003,020

(22) Filed: Jun. 7, 2018

Related U.S. Application Data
(60) Provisional application No. 62/516,591, filed on Jun. 7, 2017.

(51) Int. Cl. B62D 29/02; B62D 25/20; B32B 5/02; B32B 27/12; B32B 27/20; B29C 47/02; B29C 47/00; B29C 70/52

(52) U.S. Cl. CPC B62D 29/02; B62D 25/2054; B32B 5/02; B32B 27/12; B62D 33/02; B29C 47/025; B29C 47/0069; B29C 70/52; B32B 27/20

(57) ABSTRACT

A bamboo and/or vegetable cane composite decking and process of manufacturing. The composite decking includes planks formed from a core of bamboo fibers and a polymer layer that covers the top, bottom, and opposing side surfaces of the core. The core includes mats of bamboo fibers stacked together into layers such that the vegetable fibers extend generally parallel to the axial direction of the core. The polymer layer includes a polymer material that protects the vegetable fibers within the core from environmental damage and provides impact resistance to increase the longevity and durability of the plank. The polymer layer can also include bamboo fibers and/or dust that are mixed in with the polymer material to further increase the toughness and durability of the polymer layer.

### CROSS-REFERENCE TO RELATED APPLICATION(S)

This non-provisional patent application claims the benefit of and priority to U.S. Provisional Patent Application No. 62/516,591, titled “BAMBOO AND OR VEGETABLE CANE COMPOSITION DECKING-PLANKING AND PROCESS” and filed Jun. 7, 2017, which is incorporated herein in its entirety by reference thereto.

### TECHNICAL FIELD

Embodiments of the present technology relate to planks and structural beam components formed from a bio-composite material that includes bamboo fibers (or other vegetable cane fibers) and polymer.

### BACKGROUND

Timber decking for flatbed trailers is typically formed from hardwoods such as oak, maple, birch, beech, ash, etc. These woods typically have a high number of defects that make them unsuitable for use as decking as the defects can compromise the structural integrity of the flatbed trailer. Accordingly, a large portion of the timber is discarded or lost in the manufacturing process. Further, these woods are susceptible to damage caused by harsh environmental conditions and decking made from these woods needs to be replaced regularly to prevent the flatbed trailer from becoming unusable. For example, these woods can absorb a large amount of moisture and decking made from these hardwoods can swell. However, once the wood dries, these boards can shrink and, over the course of multiple wetting and drying cycles, the repeated expansion and contraction can cause the wood decking to crack and fail. Additionally, hardwood trees require long growth periods to reach maturity and harvesting hardwood trees can have adverse consequences for the local environment. Accordingly, there is a need for improved decking materials that are more durable than traditional timber materials and that are more sustainable to produce.

### BRIEF DESCRIPTION OF THE DRAWINGS

FIG. 1 is an isometric view of a flatbed trailer that includes decking made of composite planks configured in accordance with embodiments of the present technology.

FIG. 2 is an isometric view of a bamboo-fiber mats arranged in a stack to form a core in accordance with embodiments of the present technology.

FIG. 3 shows an isometric view of a portion of a plank having a rectangular profile and configured in accordance with an embodiment of the present technology.

FIGS. 4A and 4B show isometric views of portions of a plank having differently-shaped profiles and configured in accordance with embodiments of the present technology.

FIG. 5 is a schematic diagram of a polymer processing system that can be used to form a polymer layer through and around the core shown in FIG. 2, in accordance with embodiments of the present technology.

FIG. 6 shows a method of manufacturing the plank in accordance with embodiments of the present technology.

### DETAILED DESCRIPTION

Several embodiments of the present technology are directed to composite wood planks that include bamboo fibers and polymer. For example, the present technology can include composite planks that include a stack of bamboo fibers encapsulated within a polymer material. The stack of bamboo fibers can include multiple bamboo-fiber mats of bamboo fibers stacked together where the bamboo fibers are generally continuous and un-cut along the length of the fibers. This approach can combine the beneficial mechanical properties and sustainability of vegetable canes such as bamboo with the moldability and binding ability of the polymer to form a composite plank having a greater toughness and durability than planks formed from solid sawn timber. For example, the continuous bamboo fibers can have a high tensile strength that can allow the composite plank to securely support heavy loads without breaking, failing, or permanently deforming, while the polymer layer can be formed around the bamboo fibers to have a selected shape that allows adjacent composite planks to securely couple together to provide increased strength. The polymer layer can also include bamboo fibers embedded within the polymer material that can increase the mechanical strength of the polymer layer, thereby further increasing the durability and strength of the composite planks. As a result, structures formed from the composite planks can have a higher durability and toughness than traditional solid sawn timber planks.

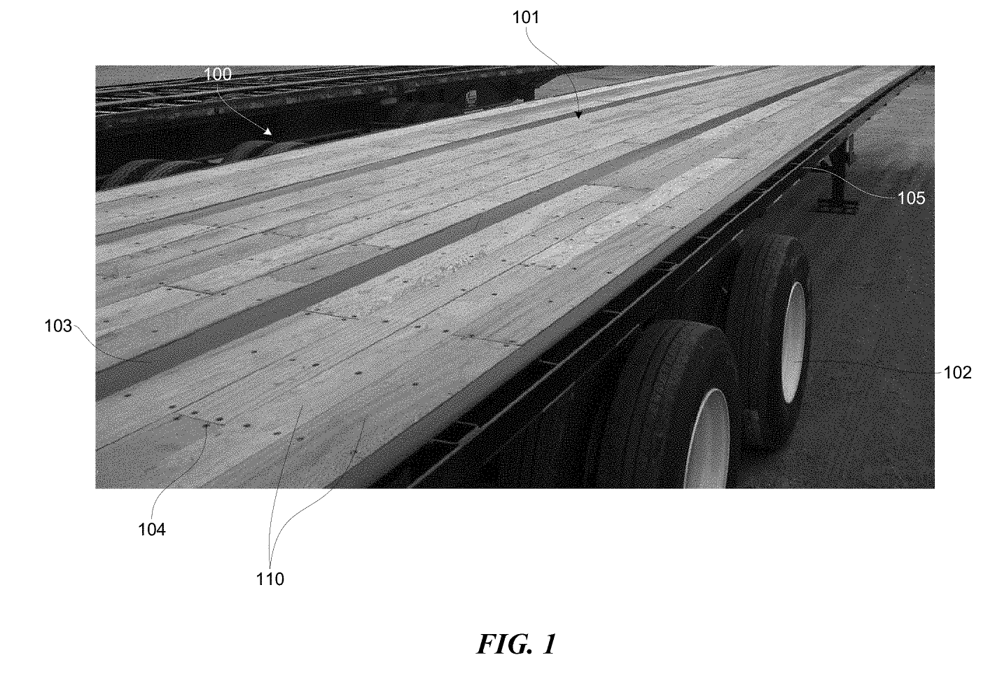

Specific details of several embodiments of the disclosed technology are described below with reference to particular representative configurations. The disclosed technology can be practiced in accordance with planks, beams, boards, and/or other suitable building structures. Specific details describing structures or processes that are well-known and often associated with vegetable cane and wood structures, but that can unnecessarily obscure some significant aspects of the presently disclosed technology, are not set forth in the following description for purposes of clarity. Moreover, although the following disclosure sets forth some embodiments of different aspects of the disclosed technology, some embodiments of the technology can have configurations and/or components different than those described in this section. For example, although specific reference is made to bamboo and bamboo fibers in the following embodiments, in other embodiments, other suitable types of vegetable cane and/or grass fibers can be used. As such, the present technology can include some embodiments with additional elements and/or without several of the elements described below with reference to FIGS. 1-6.

FIG. 1 is an isometric view of a flatbed trailer 100 that can be used to transport selected goods. The trailer 100 can be coupled to and towed by a conventional tractor. The trailer 100 includes a bed 101 and wheels 102 that support the bed 101, which can be generally planar and can have a generally rectangular shape. The bed 101 can include a metal structure 105 that includes a support frame having braces 103 that extend along the entire length of the bed 101. The bed 101 can also include planks 110 positioned between braces 103 and that are coupled to the metal structure 105. The planks 110 can be generally parallel to the length of the bed 101 and can be coupled to the metal structure 105 with conventional fasteners 104. Although FIG. 1 illustrates the planks 110 on a flatbed trailer, in other embodiments the planks 110 can be used on other trailers, trucks, railroad cars, ships, other vehicles, other platforms, or other mobile or non-mobile structures.

The planks 110 can be formed from a composite structure that includes a core formed from bamboo fibers encapsulated by a polymer material. Vegetable canes, such as bamboo, are very fibrous and are popular for use as building and textile materials. Building materials formed from bamboo fibers can have high strength comparable to that of more traditional building materials (e.g., wood, steel concrete, etc.) while being substantially cheaper to produce and manufacture and can be lighter than traditional building materials. The bamboo culms have a plurality of nodes spaced apart along their length and include fibers that extend substantially parallel to the length of the culms. The cylindrical bamboo culms can be split lengthwise and flattened into a generally planar arrangement to form mats. In some embodiments, the flattened culms can be conditioned to soften and separate the bamboo fibers and the mats include the conditioned fibers. Further details of vegetable cane processing and conditioning methods that can be used are disclosed in further detail in U.S. patent application Ser. No. 14/673,659, filed Mar. 30, 2015 and titled “APPARATUS AND METHOD FOR PROCESSING BAMBOO OR VEGETABLE CANE,” and in U.S. patent application Ser. No. 15/647,061, filed Jul. 11, 2017 and titled “APPARATUS AND METHOD FOR CONDITIONING BAMBOO OR VEGETABLE CANE FIBER,” which are incorporated herein in their entirety by reference.

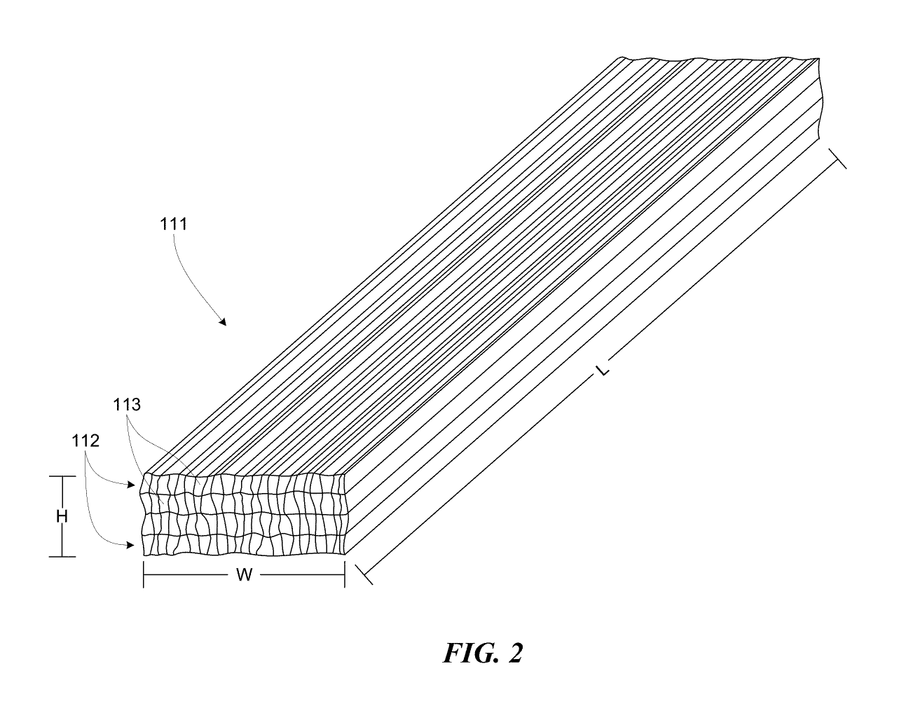

After the culms are formed into mats, the bamboo-fiber mats can be cut to a selected width and length and arranged for alignment in an encapsulated stack to form a core. FIG. 2 shows an isometric view of a core 111 having a width W, a height H, and length L. The core 111 includes a plurality of polymer-encapsulated mats 112 stacked together, and each of the mats 112 includes fibers 113 that can be axially aligned with the core 111 and can therefore be substantially parallel to each other. In the illustrated embodiment, the core 111 includes four mats 112 stacked and layered together. In other embodiments, the core 111 can include five mats 112 stacked and layered together, six or more mats 112 stacked and layered together, or fewer than four mats 112 stacked and layered together. Further, the height H of the core 111 can be based on the number of mats 112 stacked and layered together while the width W can be based on the number of fibers 113 that form each of the mats 112. In some embodiments, the core can have a selected height H that may be as standardized height or a custom selected height, and the core can have a width W that may be a standardized or custom selected site and that may be greater than, equal to, or less than the height H. In some embodiments, the plank (plank 110) can be sized and shaped similar to traditional timber building materials (e.g., 2×4, 2×8, 4×6, etc.) so that the plank can be used in place of traditional building materials. Accordingly, the height H and width W of the core 111 can be selected based on the size and shape of the traditional timber building materials.

In some embodiments, the length L of the core 111 can correspond substantially to the length of the fibers 113. For example, in embodiments for which each mat 112 is formed from fibers 113 having a length approximately equal to 6 feet the length L can also be approximately equal to 6 feet. In general, the fibers 113, and therefore the length L, can be a selected length relative to the bamboo fibers. In other embodiments, however, the length L can be substantially longer than the fibers 113. In these embodiments, at least some of the layers can include two or more mats 112 arranged generally end-to-end, such that the length L of the core 111 substantially corresponds to the cumulative length of the multiple mats 112. For example, in embodiments for which, at least one of the layers in the core 111 is formed from two mats 112 having lengths of approximately 6 feet arranged end-to-end, the length L of the core 111 can be approximately to 12 feet.

In embodiments of the core 111 for which at least some of the layers include multiple mats 112 arranged end-to-end, gaps can be formed between these adjacent mats 112. To ensure that these gaps do not significantly affect the strength of the plank, the mats 112 can be arranged such that the gaps within a given one of the layers are offset from the gaps formed between mats 112 in an adjacent layer. In this way, the mats 112 can be arranged such that the gaps do not overlap with any adjacent gaps.

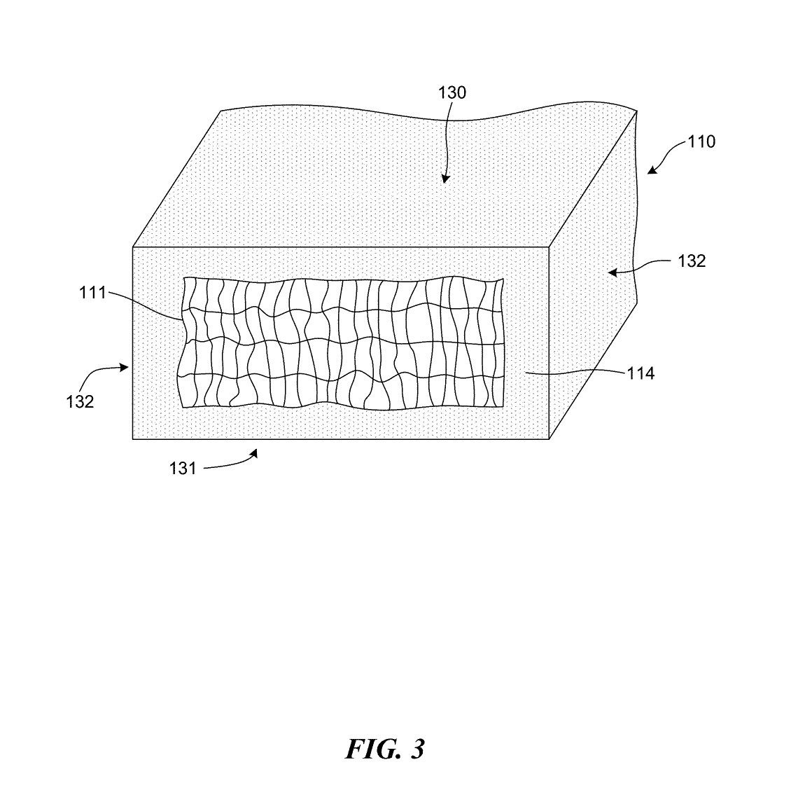

In the illustrated embodiment, during formation of the plank 110, the plurality of mats 112 are aligned adjacent to each other for formation of the core 111, and as the planks are formed the mats 112 are encapsulated in a polymer and arranged in the stack configuration, so the polymer is around, through, and/or between the mats 112. In addition, an external polymer layer is formed around the exterior of the mats 112 forming the core 111. FIG. 3 shows an isometric cross-sectional view of a portion of the plank 110 having a polymer layer 114 with a selected thickness that surrounds and encases the core 111. The resulting plank 110 can provide exceptional strength, durability, wear resistance, and robustness because the core 111 acts as a core structure that offers increased strength while the polymer layer 114 protects the fibers 113 from becoming damaged. Further, any nails, screws, anchors, or other fasteners driven through the polymer layer 114 and into the core 111 can be securely retained by the polymer material and the fibers 113. This construction also allows the planks 110 to be securely and fixedly attached to support structures, such as the metal structure 105 of FIG. 1. Additionally, the polymer layer 114 can be capable of sealing holes or abrasions formed in the polymer layer 114 (e.g., screw holes, scratches, indents from objects striking the polymer layer 114, etc.) so that the fibers 113 within the core 111 can be protected from environmental factors (e.g., rain, snow, etc.). Accordingly, the polymer layer 114 can increase the durability and wear resistance of the plank 110.

In some embodiments, the polymer used to encase the mats 112 and to form the external polymer layer 114 can be formed from a selected polymer material, such as polypropylene, HDPE, LDPE, Nylon, other suitable plastic or polymer material, or even blends of multiple polymer materials. In these embodiments, the polymer layer 114 may only include the selected polymer and may not include any additional materials or additives. In other embodiments, however, the polymer layer 114 can include the selected polymer material and can also include small pieces of bamboo fibers and/or bamboo dust embedded within the selected polymer material. Accordingly, in these embodiments, the polymer layer 114 can be formed from a bio-composite material. An example of the bio-composite material that can be used is described in Applicant's U.S. Provisional Patent Application No. 62/484,810, and U.S. Non-Provisional patent application Ser. No. 15/951,055, each of which is incorporated herein in their entirety by reference thereto. In one or more embodiments, when the bamboo culms (or other vegetable cane) are processed, cut, and flattened to form the mats 112, small pieces of fibers and dust can be left over. These remaining pieces of bamboo fibers can be collected and mixed with the selected polymer material before the polymer layer 114 is formed. While the small pieces of fiber are described in an embodiment as being a byproduct of bamboo processing, the polymer material in other embodiments can contain fibers made of bamboo, vegetable cane, or other organic or inorganic material from one or more other suitable sources. The polymer material having the bamboo fibers can be heated until the polymer material melts and the liquid mixture can be flowed in, through, and/or around the mats 112 to substantially simultaneously encapsulate the bamboo mats and form the external polymer layer 114. The bamboo fibers can increase the strength of the selected polymer material, thereby improving the durability and toughness of the plank 110.

In at least one embodiment, the small bamboo fibers can have a selected one of a plurality of sizes. For example, the small bamboo fibers can be segments of about 0.010″-0.020″ thick and about ⅛″-¼″ long. Accordingly, each of the small bamboo fibers embedded within the polymer layer 114 can be shorter than the bamboo fibers 113. Further, the polymer layer 114 can have a selected cane fiber concentration. For example, in one embodiment, the polymer layer 114 has a bamboo fiber concentration of approximately 5% by weight. In other embodiments, the polymer layer 114 can comprise a bamboo fiber concentration in the range of approximately 2%-50%, approximately 5%-20%, or approximately 8%-15%, or approximately 20%-40%, or approximately 35%-45%. Other embodiments of the compounded composite can have the bamboo fibers in combination with a polymer matrix of different concentrations depending upon the desired mechanical properties of the bio-composite material.

When forming the external polymer layer 114 around the core 111, the polymer material can be applied and shaped so that the external configuration of the plank 110 has a selected profile shape. For example, in the illustrated embodiment, the external polymer layer 114 is formed around the core 111 such that the plank 110 has a generally rectangular profile. The polymer layer 114 defines opposing top and bottom surfaces 130 and 131 and opposing side surfaces 132, all of which can be generally planar. The top and bottom surfaces 130 and 131, which can be generally rectangular, can have a selected width that defines the width of the plank 110 while the side surfaces 132, which can also be generally rectangular and can be generally perpendicular to the top and bottom surfaces 130 and 131, can have a selected height that defines the height or thickness of the plank 110. In general, the top and bottom surfaces 130 and 131 can have any suitable width while the side surfaces 132 can have any suitable height. For example, the heights and widths can be consistent with conventional board dimensions (2×4, 2×6, 2×8, 4×4, 4×8, etc.), or other selected dimensions. With this profile, multiple of the planks 110 can be arranged adjacent to each other to form a platform or structure by positioning the planks 110 such that the side surfaces 132 of the adjacent planks 110 are immediately adjacent to each other, such as forming butt joints or other configurations between the adjacent planks 110.

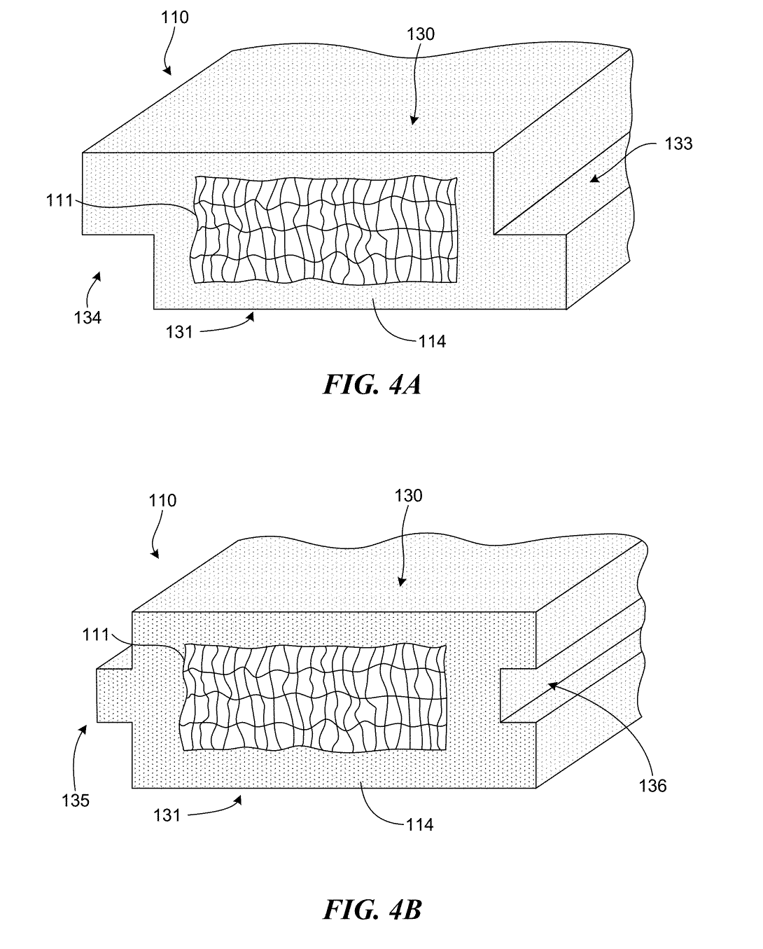

In other embodiments, however, the planks 110 can have non-rectangular profiles. For example, FIGS. 4A and 4B show embodiments of the plank 110 having non-rectangular profiles. In the embodiment shown in FIG. 4A, the plank 110 has a shiplap profile. In this embodiment, the plank 110 can include the top and bottom surfaces 130 and 131 and can also include first and second rabbet portions 133 and 134, which can extend along the length of the plank 110. The first and second rabbet portions 133 and 134 can be formed from recesses in the polymer layer 114 adjacent to the top and bottom surfaces 130 and 131, respectively. With this profile, arranging multiple of the planks 110 adjacent to each other to form a platform can include positioning the planks 110 such that the second rabbet portions 134 from each of the planks 110 overlaps with the first rabbet portions 133 from an adjacent plank 110.

In the embodiment shown in FIG. 4B, the plank 110 has a tongue and groove profile. In this embodiment, the plank 110 can include the top and bottom surfaces 130 and 131 and can also include a tongue portion 135 and a groove portion 136, both of which can extend along the length of the plank 110. The polymer layer 114 can include a ridge or projection that defines the tongue portion 135 and a channel that defines the groove portion 136. The tongue and groove portions 135 and 136 can be sized and shaped such that the tongue portion 135 closely fits within the groove portion 136 with a secure functional engagement. With this profile, arranging multiple of the planks adjacent to each other to form a platform can include positioning the multiple planks 110 such that the tongue portion 135 from each of the planks 110 is positioned within the groove portion 136 of an adjacent plank 110. In other embodiments, the planks 110 can have other conventional or custom joinery configurations for connection to adjacent planks or to other structures.

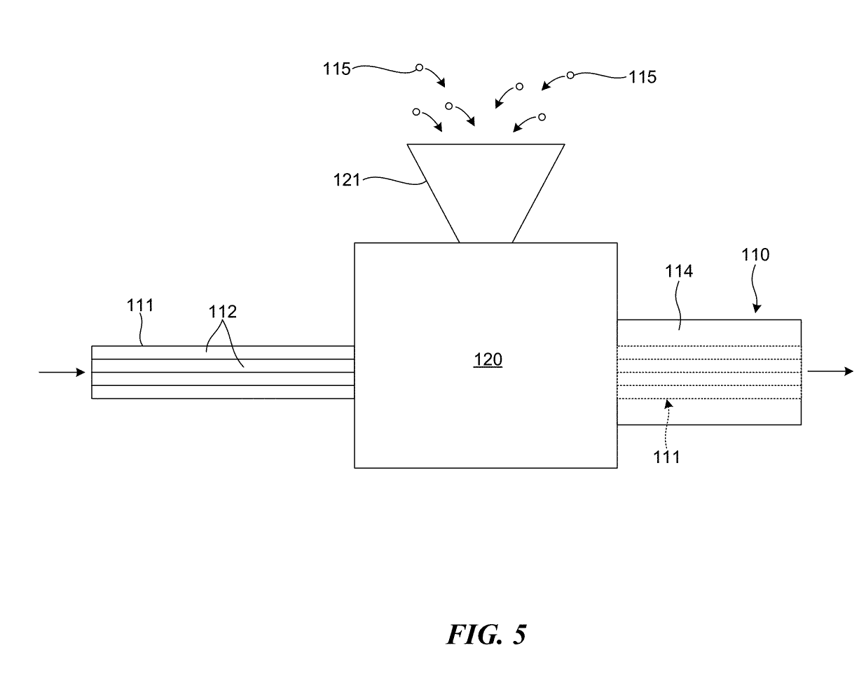

To form the polymer layer 114, the core 111 can be provided to a polymer processing system. FIG. 5 shows a schematic view of the bamboo mats 112 being inserted into a polymer processing system 120 that can be used to apply the polymer to and around the mats, including between the mats, and to form the external polymer layer 114 around the core 111 formed by the stacked, polymer-encapsulated mats 112. The system 120 can include a hopper 121 positioned to receive beads 115. The hopper 121 provides the beads 115, which can be formed from the selected polymer material, to a heater apparatus that can heat the beads 115 until the selected polymer material melts into a flowable liquid. The system 120 can also include a polymer distribution system that receives the liquid polymer material from the heater apparatus and that can flow the liquid polymer material over, between, and/or around the mats 112 as the mats 112 moves through, as an example, an extrusion or pultrusion head of the system 120. In embodiments for which the polymer layer 114 includes bamboo fiber pieces and/or dust, the beads 115 can include the fiber pieces such that flowing the liquid polymer material over the mats 112 also include flowing the fiber pieces over the mats 112 forming the core 111 and the external polymer layer around the core 111. The polymer processing system 120 can also include a cooler or chiller positioned to receive the plank 110 after exiting the extrusion or pultrusion head. The cooler can be used to cool the liquid polymer material to cause it to set and solidify. After the polymer material cools sets and the external configuration of the polymer layer 114 is formed, the plank 110 can be removed from the system 120 and can be cut to a selected length.

In some embodiments, the polymer processing system 120 includes a separator apparatus that can spread the mats 112 apart from each other as they enter the polymer processing system 120. As the mats 112 pass through the polymer distribution system, the liquid polymer provided to the mats 112 can pass into the space between the separated mats 112 so that the polymer material can cover the fibers of the mats forming the core 111. The mats 112 can then be pressed together in the head (e.g., with a press, rollers, etc.) to force at least some of the liquid polymer between the mats 112 to flow through the mats 112 and surround the fibers so that the fibers can be impregnated by the polymer material once the polymer material hardens and cures. In this way, the strength of the fibers can be increased and the strength of the plank 110 can also be increased. In some embodiments, the gap can be approximately 1/32^{nd} of an inch, while in other embodiments, the gap can be approximately 1/16^{th} of an inch or another selected dimension.

In some embodiments, the polymer distribution system comprises an extrusion system. In these embodiments, the mats 112 are pushed (e.g., with rollers on opposing sides of the core, with a press that applies a pushing force to the mats) through the die opening in the extrusion head. In other embodiments, the polymer distribution system comprises a pultrusion system. In these embodiments, the mats 112 are pulled (e.g., with a puller unit, etc.) through the die opening in the head. In either of these embodiments, extrusion or pultrusion head receives the liquid polymer material and distributes the polymer material to, through, and/or around the mats, and substantially simultaneously form the external polymer layer 114 around the core 111.

The die opening in the head can have a selected shape and forcing the core 111 and the flowable polymer material through the opening can cause the polymer material forming the external polymer layer 114 to conform to the selected shape, which can correspond to the external shape of the plank 110 and any integral joinery if desired. For example, in embodiments of the plank 110 that have a generally rectangular profile (FIG. 3), the opening can also have the generally rectangular shape. In other embodiments, the opening can be shaped such that the plank 110 can have a shiplap profile (FIG. 4A) or a tongue and groove profile (FIG. 4B). In this way, the extrusion system can be able to form planks 110 having a variety of profile shapes by using dies having differently shaped openings. Accordingly, the plank 110 can be manufactured to have any suitable profile shape without changing the shape or structure of the internal core 111.

In some embodiments, the polymer processing system 120 can include a surface treatment apparatus positioned to receive the plank 110 before the cooler receives the plank 110. The surface treatment apparatus can be configured to form a selected pattern or print into the surface of the polymer layer 114. In some embodiments, the selected pattern or print can help to increase the performance of the plank 110. For example, the selected pattern or print can include a knurling pattern that can provide increased grip and traction between the plank 110 and an object positioned on the plank 110. In other embodiments, the selected pattern can be a decorative pattern that provides an improved aesthetic appearance. For example, the selected pattern can include a wood grain pattern. In still other embodiments, the selected pattern can include a logo or symbol. In general, the surface treatment apparatus can form any suitable pattern into the soft polymer material. After forming the pattern or print, the plank 110 can be provided to the cooler.

In some embodiments, the polymer layer 114 can have one or more selected colors. The polymer layer 114 can also include selective additives, such as mold inhibitors, dyes, or even a luminous material embedded within the polymer material that can emit light. The luminous material can be used to increase visibility, and therefore safety, when the planks 110 are used in low light conditions.

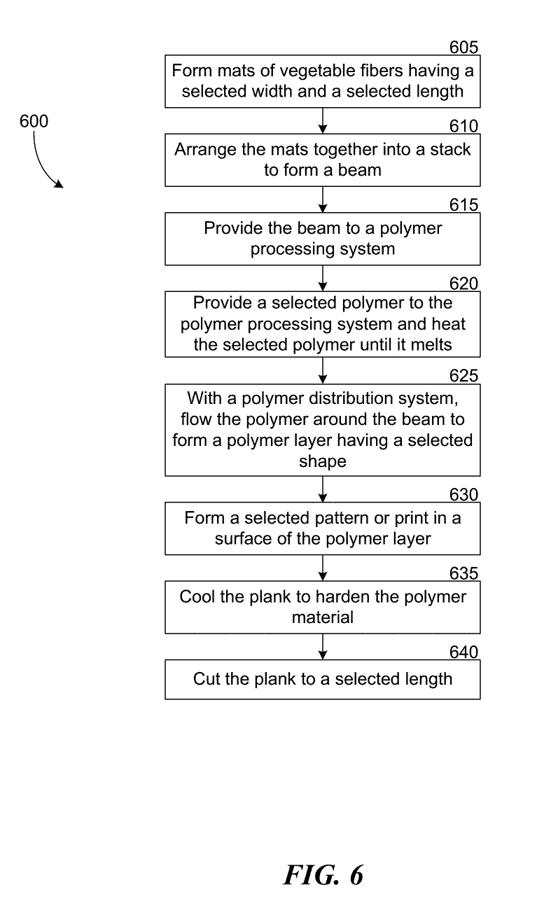

FIG. 6 shows a method 600 of manufacturing the plank 110. At step 605, mats of bamboo fibers are formed. The mats are formed by cutting vegetable canes (e.g., bamboo culms) to a selected length and slicing the canes along the length to allow the cane to open. The canes are then flattened and cut into mats having a selected width. In some embodiments, the flattened canes can also be conditioned.

At step 610, the mats are stacked together to form a core and at step 615, the core is provided to a polymer processing system. The mats are arranged in layers such that the individual bamboo fibers within each of the mats extend along the length of the mat and are generally parallel to each other as well as to the axial direction of the core.

At step 620, a selected polymer is provided to the polymer processing system and the selected polymer is heated until it melts. The selected polymer is initially formed as a plurality of beads and the polymer processing system includes a hopper positioned to receive the beads. The polymer processing system also includes a heater positioned to receive the beads from the hopper and to heat the beads until the selected polymer melts. The selected polymer can include any suitable polymer material and, in some embodiments, can include bamboo fiber pieces and/or dust mixed with the suitable polymer material.

At step 625, a polymer distribution system is used to flow the liquid polymer material over, between, and through the mats to encapsulate the mats. The polymer distribution system also flows the polymer material around the exterior area of the mats as the mats and the polymer move through a die opening in the extrusion or pultrusion head, wherein the die opening has a selected shape. The core and external polymer layer exit die opening in the head with the selected external shape.

At step 630, a pattern or print is formed in a surface of the polymer material. The print or pattern can be decorative and/or functional (e.g., a wood grain pattern, a diamond plate pattern, a logo, a knurling pattern, or other pattern).

At step 635, the plank is provided to a cooler that cools the polymer layer down so that the polymer material sets and solidifies and at step 640, the plank is cut to a selected length.

In the foregoing embodiments of the current technology, the composite planks are discussed in connection with bamboo cores, mats, and fibers. In other embodiments, fibers from other suitable types of vegetable canes or grasses can be used.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A composite plank comprising:
a bamboo fiber core having opposing top and bottom surfaces and opposing first and second side surfaces, wherein the bamboo fiber core comprises at least one mat formed by a plurality of bamboo fibers; and
a polymer layer formed around the bamboo fiber core and that completely covers the top surface, the bottom surface, the first side surface, and the second side surface.

2. The composite plank of claim 1 wherein the at least one mat comprises a plurality of mats arranged in layers.

3. The composite plank of claim 2 wherein the bamboo fibers in the plurality of bamboo mats are substantially encapsulated in the polymer layer along the length of the bamboo fibers.

4. The composite plank of claim 2 wherein the each of the plurality of mats are arranged in a stack with substantially no lateral offset between adjacent mats.

5. The composite plank of claim 1 wherein the polymer layer comprises a polymer material from the group consisting of polypropylene, HDPE, LDPE, and Nylon.

6. The composite plank of claim 1 wherein the plurality of bamboo fibers comprises a first plurality of interconnected bamboo fibers, and the polymer layer comprises a polymer material and a second plurality of bamboo fibers embedded within the polymer material.

7. The composite plank of claim 2 wherein at least one of the plurality of mats has a first width and a first length, the bamboo fiber core has a second width and a second length, and the first width is substantially the same as the second width.

8. The composite plank of claim 7 wherein the first length is substantially the same as the second length.

9. The composite plank of claim 8 wherein the composite plank has a third length substantially the same as the first and second lengths.

10. The composite plank of claim 7 wherein the first length is less than the second length.

11. A composite decking assembly for use with a support structure, comprising:
a plurality of interconnectable composite planks couplable to the support structure, wherein each of the planks comprises:
an bamboo core that comprises a plurality of bamboo fibers; and
a polymer layer formed around the internal bamboo core, wherein—
each of the composite planks comprises opposing top and bottom surfaces and opposing first and second side portions extending between the top and bottom surfaces, and
the polymer layer defines the top and bottom surfaces and the first and second side portions.

12. The composite decking assembly of claim 11 wherein the support structure forms a portion of a flatbed trailer.

13. The composite decking assembly of claim 11 wherein each of the plurality of composite planks has a rectangular profile.

14. The composite decking assembly of claim 11 wherein the first and second side portions have integral joinery features therein.

15. The composite decking assembly of claim 14 wherein the joinery features are tongue and groove features.

16. The composite decking assembly of claim 9 wherein—
each of the plurality of composite planks has a shiplap profile,
for each of the plurality of composite planks, the first side portion comprises a first rabbet portion adjacent to the top surface and the second side portion comprises a second rabbet portion positioned adjacent to the bottom surface, and
the first rabbet portion being configured to overlap with the second rabbet portion of an adjacent composite plank.

17. The composite decking assembly of claim 11 wherein—
each of the plurality of composite planks has a tongue and groove profile,
for each of the first plurality of composite planks, the first side portion comprises a tongue portion and the second side portion comprises a groove portion,
the tongue portion being configured to fit within the groove portion of adjacent composite planks.

18. The composite decking assembly of claim 11 wherein—
the plurality of fibers comprises a first plurality of bamboo fibers,
the polymer layer comprises a polymer material and a second plurality of bamboo fibers embedded within the polymer material.

19. The composite decking assembly of claim 11 wherein the fiber core comprises a plurality of mats formed from the fibers stacked together to form layers.

20. A method of manufacturing a composite plank, comprising:
forming generally flat mats of comprising interconnected bamboo fibers;
layering the mats together to form an internal core;
flowing a polymer material around the internal core to form a polymer layer that substantially encapsulates the bamboo fibers along their length; and
cooling the polymer material.

21. The method of claim 20, further comprising passing the polymer covered internal core through an extrusion dye or a pultrusion dye.

22. The method of claim 20, further comprising:
before cooling the polymer material, forming a selected pattern in a top surface of the polymer layer.
